(19) United States
(12) Patent Application Publication
(10) Pub. No.: US 2013/0212408 A1
(43) Pub. Date: Aug. 15, 2013

(54) REGULATING A CLOCK FREQUENCY OF A PERIPHERAL

(71) Applicant: Kenneth W. Fernald, Austin, TX (US)

(72) Inventor: Kenneth W. Fernald, Austin, TX (US)

(21) Appl. No.: 13/369,667

(22) Filed: Feb. 9, 2012

(51) Int. Cl. G06F 1/00

(52) U.S. Cl. 713/300

(57) ABSTRACT

A method of communicating in an electronic system or apparatus is disclosed. The method includes using a processor to communicate with a peripheral. The processor has a power state. The method also includes regulating a clock frequency of the peripheral, where this regulation is based at least in part on the power state of the processor.

### BACKGROUND

An electronic device may include a microcontroller unit (MCU) for a number of different applications. For example, the electronic device may use a processor core of the MCU to process incoming and outgoing streams of data for the electronic device. As a more specific example, the electronic device may be a mobile telecommunications device (a smartphone, for example) that uses the processor core of the MCU to process data communicated over a wireless network.

### SUMMARY

In an exemplary implementation, a technique includes using a processor to communicate with a peripheral and regulating a clock frequency of the peripheral based at least in part on a power state of the processor.

In another exemplary implementation, an apparatus includes a peripheral and a processor, which is adapted to communicate with the peripheral. The peripheral is adapted to regulate its clock frequency based at least in part on a power state of the processor.

In yet another exemplary implementation, an apparatus includes an integrated circuit that includes a processor and a peripheral. The processor is adapted to communicate with the peripheral, and the peripheral is adapted to regulate its clock frequency based at least in part on a power state of the processor.

Advantages and other desired features will become apparent from the following drawing, description and claims.

### BRIEF DESCRIPTION OF THE DRAWING

FIG. 1 is a schematic diagram of a transceiver system according to an exemplary embodiment.

FIG. 2 is a schematic diagram of a microcontroller unit of the system of FIG. 1 according to an exemplary embodiment.

FIG. 3 is a flow diagram depicting a technique to regulate a clock frequency of a peripheral of the microcontroller unit according to an exemplary embodiment.

FIG. 4 is a flow diagram depicting a technique employed by the peripheral to regulate its clock frequency according to an exemplary embodiment.

FIG. 5 is a schematic diagram of a subsystem of the microcontroller unit according to an exemplary embodiment.

### DETAILED DESCRIPTION

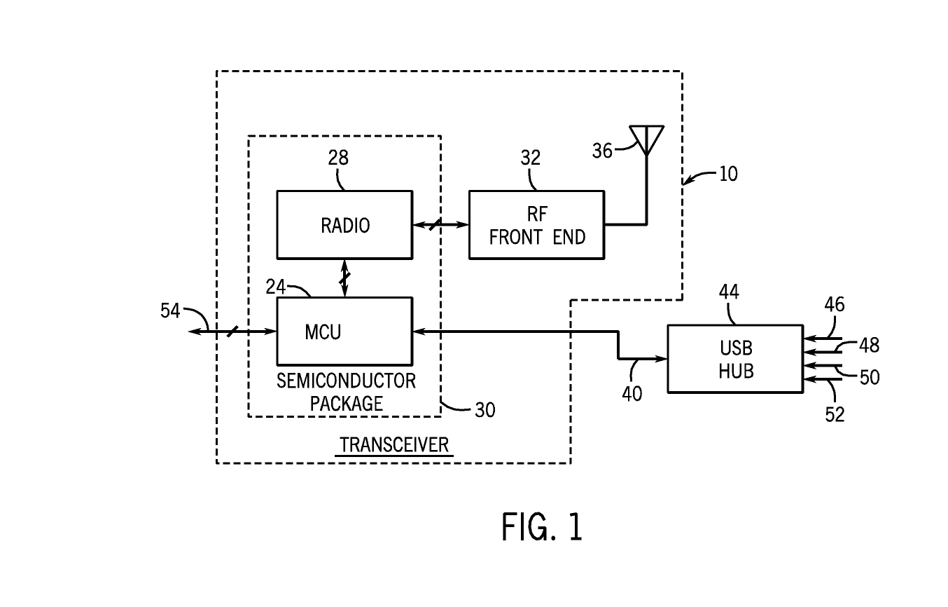

Referring to FIG. 1, in accordance with embodiments disclosed herein, an embedded microcontroller unit (MCU) 24 may be used in a variety of applications, such as applications in which the MCU 24 controls various aspects of a transceiver 10 (as a non-limiting example). In this regard, the MCU 24, for this particular example, may be part of an integrated circuit (IC), or semiconductor package 30, which also includes a radio 28. As a non-limiting example, the MCU 24 and the radio 28 may collectively form a packet radio, which processes incoming and outgoing streams of packet data. To this end, the transceiver 10 may further include a radio frequency (RF) front end 32 and an antenna 36, which receives and transmits RF signals (frequency modulated (FM) signals, for example) that are modulated with the packet data.

As non-limiting examples, the transceiver 10 may be used in a variety of applications that involve communicating packet stream data over relatively low power RF links and as such, may be used in wireless point of sale devices, imaging devices, computer peripherals, cellular telephone devices, etc. As a specific non-limiting example, the transceiver 10 may be employed in a smart power meter which, through a low power RF link, communicates data indicative of power consumed by a particular load (a residential load, for example) to a network that is connected to a utility. In this manner, the transceiver 10 may transmit packet data indicative of power consumed by the load to mobile meter readers as well as to an RF-to-cellular bridge, for example. Besides transmitting data, the transceiver 10 may also receive data from the utility or meter reader for such purposes (as non-limiting examples) as inquiring as to the status of various power consuming devices or equipment; controlling functions of the smart power meter; communicating a message to a person associated with the monitored load, etc.

As depicted in FIG. 1, in addition to communicating with the radio 28, the MCU 24 may further communicate with other devices and in this regard may, as examples, communicate over communication lines 54 with a current monitoring and/or voltage monitoring device of the smart power meter as well as communicate with devices over a serial bus 40. In this manner, the serial bus 40 may include data lines that communicate clocked data signals, and the data may be communicated over the serial bus 40 data in non-uniform bursts. As a non-limiting example, the serial bus may be a Universal Serial Bus (USB) 40, as depicted in FIG. 1, in accordance with some implementations. As described herein, in addition to containing lines to communicate data, the serial bus, such as the USB 40, may further include a power line (a 5 volt power line, for example) for purposes of providing power to serial bus devices, such as the MCU 24. Various USB links 46, 48, 50 and 52 may communicate via a hub 44 and USB 40 with the transceiver 10 for such purposes as communicating with a residential computer regarding power usage of various appliances, communicating with these appliances to determine their power usages, communicating with the appliances to regulate their power usages, etc.

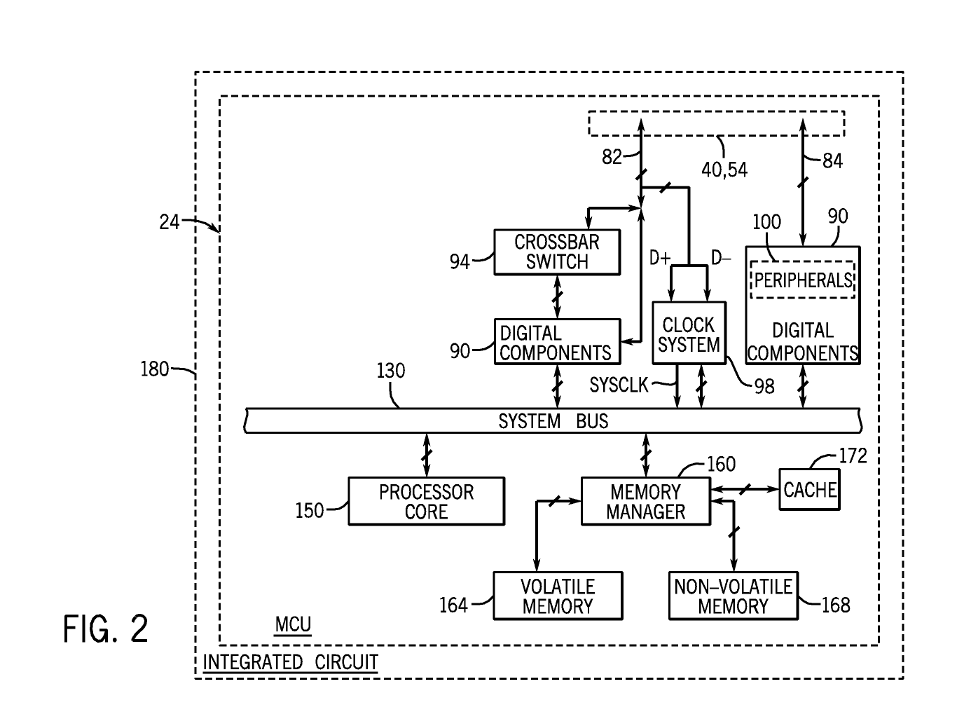

As depicted in FIG. 2, and in accordance with some embodiments, the MCU 24 includes a processor core 150. As a non-limiting example, the processor core 150 may be a 32-bit core, such as the Advanced RISC Machine (ARM) processor core, which executes a Reduced Instruction Set Computer (RISC) instruction set. In general, the processor core 150 communicates with various other system components of the MCU 24, such as a memory controller, or manager 160, over a system bus 130. In general, the memory manager 160 controls access to various memory components of the MCU 24, such as a cache 172, a non-volatile memory 168 (a Flash memory, for example) and a volatile memory 164 (a static random access memory (SRAM), for example).

For purposes of producing clock signals for use by the components of the MCU 24, such as the processor core 150, the MCU 24 includes a clock system 98. As depicted in FIG. 2, for purposes of an example, the clock system 98 is depicted as providing a system clock signal called “SYSCLK” in FIG. 2 to the system bus 130. In general, the clock system 98 recovers a clock signal used in the communication of bursty data on data lines (labeled as the “D+” and “D−” in FIG. 2) over the USB 40 and may use this recovered clock signal as the system clock signal.

The MCU 24 includes various digital components 90, such as peripherals 100 that communicate with the processor core 150, such as (as non-limiting examples) a USB interface, a programmable counter/timer array (PCA), a universal asynchronous receiver/transmitter (UART), a system management bus (SMB) interface, a serial peripheral (SPI) interface, and so forth. The MCU 24 may include a crossbar switch 94, which permits the programmable assigning of the digital peripheral components 90 to digital output terminals 82 of the MCU 24. In this regard, the MCU 24 may be selectively configured to selectively assign certain output terminals 82 to the digital peripheral components 90.

In accordance with some implementations, the MCU 24 includes an analog system 96, which communicates analog signals on external analog terminals 84 of the MCU 24 and generally forms the MCU's analog interface. As an example, the analog system 96 may include various components that receive analog signals, such as analog-to-digital converters (ADCs), comparators, etc.; and the analog system 96 may include components (supply regulators) that furnish analog signals (power supply voltages, for example) to the terminals 84, as well as components, such as current drivers.

As depicted in FIG. 2, in accordance with some embodiments, the MCU 24 may be part of an integrated circuit 180. In some embodiments, all of the components of the MCU 24 may be fabricated on a single die of the integrated circuit, and in other embodiments, the components of the MCU 24 may be fabricated on more than one die of the integrated circuit 180.

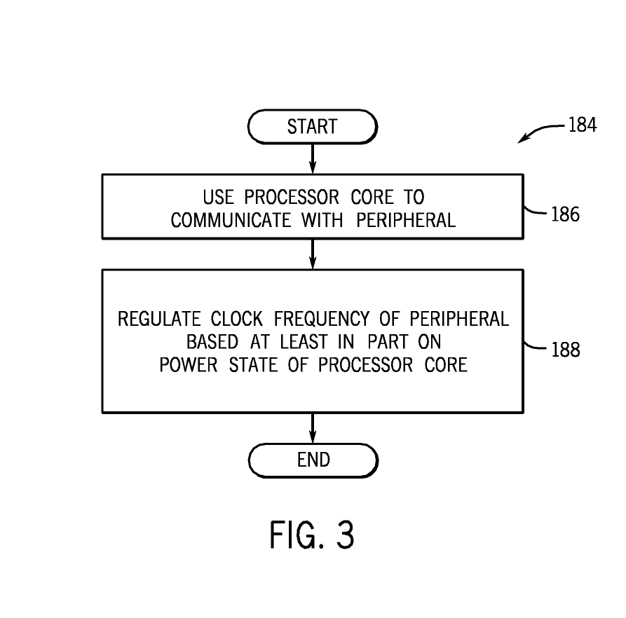

In accordance with embodiments disclosed herein, one or more of the peripherals 100 regulate its clock frequency based on a power state of the processor core 150. More specifically, referring to FIG. 3 in conjunction with FIG. 2, in accordance with exemplary implementations, a technique 184 includes using a processor core to communicate with a peripheral, pursuant to block 186, and regulating (block 188) a clock frequency of the peripheral based at least in part on a power state of the processor core.

The ability of the peripheral 100 to regulate its clock frequency allows the peripheral 100 to operate at a relatively lower clock frequency (and operate at a correspondingly lower power state) while the peripheral 100 is idle, and thereafter, transition to operate at a higher clock frequency (and thus, operate at a correspondingly higher power state) when the peripheral 100 communicates with the processor core 150. The increased clock frequency, in turn, allows the processor core 150 to relatively quickly communicate data with the peripheral 100 to reduce the time that the processor core 150 may otherwise spend outside of its lower power state.

In accordance with some embodiments, the peripheral 100 regulates its clock frequency by selecting the clock signal that is received at a clock input terminal of the peripheral 100. In this manner, to operate at a relatively lower clock frequency, the peripheral 100 selects a relatively lower frequency clock signal and to operate at a higher clock frequency, the peripheral selects a relatively higher frequency clock signal.

As a more specific example, the peripheral 100 may be a universal asynchronous receiver/transmitter (UART) device, which, when not exchanging data with the MCU 24, is clocked by a relatively low frequency clock signal such as a clock signal that is provided by a real time clock (RTC) oscillator of the MCU 24 (as a non-limiting example). In this manner, the RTC oscillator may provide a relatively low frequency clock signal, such as a clock signal of 32.768 kilo Hertz (kHz), and the UART device operates in a relatively low power state while being clocked by the RTC clock signal. The UART device may transition to a higher power state in response to receiving data communicated to the UART device over a serial communication link. In response to receiving data, the UART device wakes up the processor core 150 such as, for example, by communicating a wake up signal to the processor core 150 or by asserting an interrupt signal, which is routed to the processor core 150.

When the processor core 150 wakes up, or returns from a lower power state (a suspend state, as a non-limiting example), the processor core 150 enters its active mode, a higher power state, and in the active mode, the processor core 150 communicates with the UART device to retrieve the data from the UART device. After this operation is complete, the processor core 150 may then return to the lower power state, or idle state, if the processor core 150 does not have any further processing.

A particular advantage of using the peripheral to regulate its clock frequency regulation is that when the peripheral 100 operates at a relatively higher frequency, the processor core 150 spends less time retrieving the data such that the processor core 150 may return in less time to its lower power state. Thus, the time that the processor core 150 spends accessing the data from the peripheral 100 is reduced, and the time that the processor core 150 may remain in its lower power state is extended.

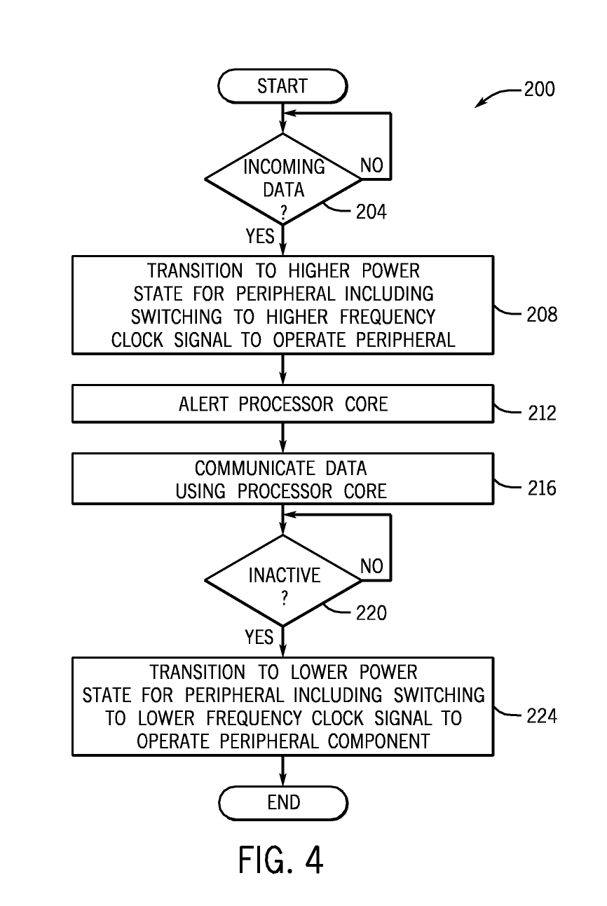

Referring to FIG. 4 in conjunction with FIG. 2, in accordance with an exemplary implementation, the peripheral 100 may employ a technique 200 for purposes of regulating its clock frequency. For this example, the peripheral transitions to a higher power state in response to the peripheral receiving data from a bus, although the peripheral may transition between relatively low power consumption and higher power states in response to other events, in accordance with other embodiments. Pursuant to the technique 200, the peripheral 100 operates in a relatively lower power state while monitoring (decision block 204) for incoming data or transmitting outgoing data. In this manner, the peripheral 100 may transition from decision block 204 in response to receiving a given number of bytes of data from a bus. When this threshold is met, the peripheral 100 transitions (block 208) to a relatively higher power state for the peripheral, a transition that includes switching its operation to a relatively higher frequency clock signal. Thus, after the transition, the peripheral 100 is operating at a higher clock frequency, which is used to clock the peripheral 100 to allow the peripheral 100 to communicate at a higher rate with the processor core 150.

Continuing the example, the peripheral 100 alerts (block 212) the processor core about the received data. This alert may be in one of numerous forms, depending on the particular embodiment. For example, in accordance with some embodiments, the peripheral 100 may assert an interrupt signal to which an interrupt controller of the MCU 24 responds by generating an interrupt signal on a corresponding input of the processor core 150. As another variation, the peripheral 100 may assert a signal that is coupled to a given input of the processor core 150 for purposes of alerting the processor core 150 to the data that is received by the peripheral 100. If the processor core 150 is in a lower power state (a suspend mode, for example), then the processor core 150 transitions from the lower power state to a higher power state for purposes of communicating data with the peripheral 100.

Thus, pursuant to the technique 200, the peripheral communicates data to or from the processor core 150, pursuant to block 216. After this data has been communicated, the peripheral 100 determines (decision block 220) whether the peripheral 100 is inactive for purposes of determining whether to transition into the lower power state. In this manner, depending on the particular implementation, the peripheral 100 may wait for a predetermined time after communicating with the processor core 150 for purposes of determining whether to transition into the lower power state. Thus, if more data is received or the peripheral 100 otherwise has more processing, the peripheral 100 may remain in the higher power state. As another example, the processor core 150 may determine when the peripheral 100 should return to the lower power state. Other variations are contemplated and are within the scope of the appended claims.

If the peripheral 100 determines (decision block 220) that the peripheral 100 is inactive (decision block 220), then, in accordance with an exemplary implementation, the peripheral 100 transitions to a lower power state, which includes switching the clock signal to the peripheral 100 to a lower frequency, pursuant to block 224.

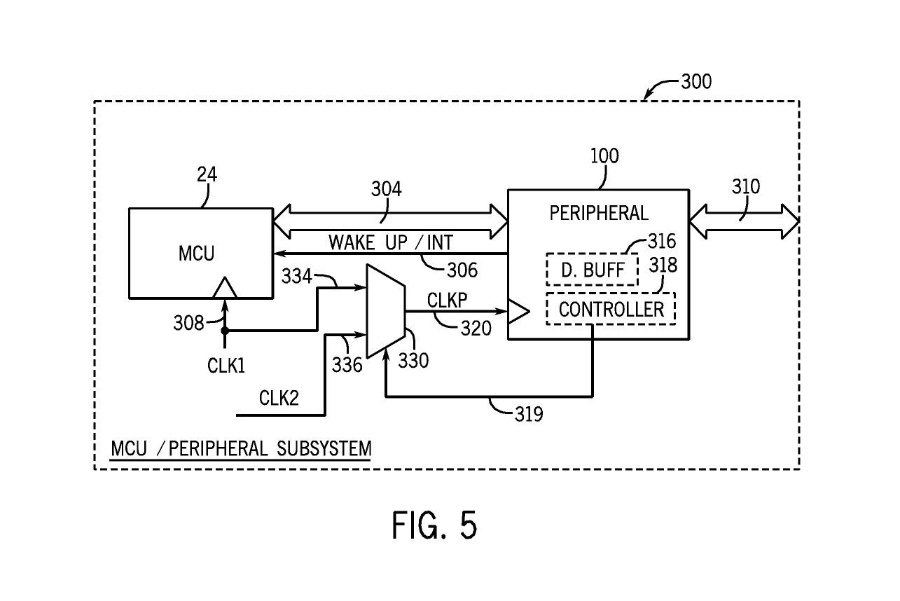

Referring to FIG. 5, in accordance with exemplary embodiments, the MCU 24 may include a processor core/peripheral subsystem 300, in accordance with exemplary implementations. As depicted in FIG. 5, for this example, the peripheral 100 includes a data buffer 316, which temporarily stores incoming data that is received from a communication link 310. As a non-limiting example, the communication link 310 may be a serial bus, such as a universal synchronous/asynchronous receiver/transmitter (USART) bus, a universal asynchronous receiver/transmitter (UART) bus, a serial peripheral interface (SPI) bus, an inter-integrated circuit (I²C) bus interface, etc. Upon receiving a predetermined amount of data from the communication link 310, a controller 318 of the peripheral 100, in accordance with exemplary embodiments, transitions the peripheral 100 from a lower power state to a higher power state to prepare the peripheral 100 to communicate with the processor core 150.

As part of this preparation, the controller 318 changes a clock signal that is provided to clock the components of the peripheral 100 (including the controller 318). More specifically, in accordance with an exemplary implementation, the controller 318 controls a multiplexer 330, which selects the clock source, or clock signal, for the peripheral 100. As depicted in FIG. 5, in general, the multiplexer 330 has an output terminal that is coupled to an input clock terminal 320 of the peripheral 100 and furnishes a clock signal (called “CLKP” in FIG. 5). The controller 318 controls a select terminal 319 of the multiplexer 330, for purposes of selecting either a CLK1 clock signal (provided at input terminal 334 of the multiplexer 330) or a CLK2 clock signal (provided an input terminal 336 of the multiplexer 330). As depicted in FIG. 5, in accordance with some implementations, the CLK1 clock signal is the same clock signal received at an input clock terminal 308 of the processor core 150. The CLK2 clock signal may be, as a non-limiting example, in general, a lower frequency clock signal (than the CLK1 clock signal) and may be, as a non-limiting example, an RTC clock signal provided by an RTC oscillator of the MCU 24.

When the peripheral 100 is not communicating with the processor core 150, the controller 318 selects the lower frequency CLK2 clock signal to clock the components of the peripheral 100. However, when the controller 318 prepares the peripheral 100 to communicate with the processor core 150, the controller 318 selects the relatively higher clock frequency by controlling the multiplexer 330 to select the CLK1 clock signal to clock the components of the peripheral 100.

As depicted in FIG. 5, the controller 318 also controls a signal that is asserted on a communication line 306 for purposes of alerting, or “waking up,” the processor core 150. In this manner, the controller 318, in accordance with exemplary implementations, may assert the signal on the communication line 306 before or near or slightly after the switching of the multiplexer 330 to route the higher frequency clock signal to the peripheral 100. Depending on the particular implementation, the signal communication on the line 306 may be an interrupt signal, which is provided directly to the processor core 150 or to an interrupt controller for purposes of generating an interrupt signal at a corresponding input of the processor core 150. As another variation, the signal communicated on the line 306 may be a signal that is communicated directly to the processor core 150 or a power management unit for purposes of serving as a wake up signal to the processor core 150. Regardless of the particular implementation, in response to the alert by the peripheral 100, the processor core 150 transitions from its lower power state (an idle mode, for example) to a higher power state and then communicates with the peripheral 100 over a bus 304 (the system bus, for example) for purposes of transferring data to or from the data buffer 316 of the peripheral 100.

In accordance with an exemplary embodiment, when the processor core 150 is idle, the MCU 24 removes the CLK1 signal. Thus, in accordance with an exemplary embodiment, when the processor core 150 is idle, the CLK1 clock signal is provided to the clock input terminal 308 of the processor core 150 or to the input terminal 334 of the multiplexer 330. Therefore, initially, when the controller 318 controls the multiplexer 330 to select the CLK1 clock signal, the CLK1 clock signal may not be available, and as a result, a clock signal may not be provided to the clock input terminal 320 of the peripheral 100. Therefore, in accordance with some implementations, the peripheral 100 may temporarily stall after the controller 318 sets up the configuration for the peripheral 100 to operate from the higher frequency CLK2 clock signal. However, after the processor core 150 wakes up and transitions from the lower power state to the higher power state, the CLK1 signal is thereafter provided both to the processor core 150 and to the peripheral 100.

While a limited number of embodiments have been disclosed herein, those skilled in the art, having the benefit of this disclosure, will appreciate numerous modifications and variations therefrom. It is intended that the appended claims cover all such modifications and variations.

What is claimed is:

1. A method comprising:
in a first power state of a processor, using the processor to communicate with a peripheral; and
regulating a clock frequency of the peripheral based at least in part on a power state of the processor.

2. The method of claim 1, wherein regulating the clock frequency further comprises changing the clock frequency of the peripheral.

3. The method of claim 1, wherein
the processor is adapted to transition between a first power state to a second power state, the second power state being associated with a greater power consumption than a power consumption associated with the first power state; and
regulating the clock frequency further comprises changing the clock frequency from a first frequency to a second frequency greater than the first frequency.

4. The method of claim 1, wherein
the processor is adapted to transition between a first power state and a second power state, the second power state being associated with a greater power consumption than a power consumption associated with the first power state; and
regulating the clock frequency further comprises changing the clock frequency from a first frequency to a second frequency less than the first frequency.

5. The method of claim 1, further comprising:
using the peripheral to trigger transition of the processor from a first power state to a second power state,
wherein the processor is adapted to transition from the first power state to the second power state, the second power state being associated with a greater power consumption than a power consumption associated with the first power state.

6. The method of claim 5, wherein the triggering comprises performing one of communicating a wakeup signal and communicating an interrupt signal.

7. The method of claim 6, further comprising:
using the peripheral to trigger transition of the processor from a first power state to a second power state in response to the peripheral transitioning from a third power state to a fourth power state,
wherein the processor is adapted to transition between the first power state and the second power state, the second power state being associated with a greater power consumption than a power consumption associated with the first power state; and the peripheral is adapted to transition between the third power state and the fourth power state, the fourth power state being associated with a greater power consumption than a power consumption associated with the third power state.

8. The method of claim 7, further comprising transitioning the peripheral from the third power state to the fourth power state in response to the peripheral transmitting or receiving data.

9. An apparatus comprising:
a peripheral;
a processor adapted to communicate with the peripheral,
wherein the peripheral is adapted to regulate a clock frequency of the peripheral based at least in part on a power state of the processor.

10. The apparatus of claim 9, wherein the peripheral is adapted to change the clock frequency of the peripheral to prepare the peripheral for communication with the processor.

11. The apparatus of claim 9, wherein
the processor is adapted to transition between a first power state and a second power state, the second power state being associated with a greater power consumption than a power consumption associated with the first power state; and
the peripheral is adapted to change the clock frequency from a first frequency to a second frequency greater than the first frequency.

12. The apparatus of claim 11, wherein the peripheral is adapted to alert the processor to transition the processor from the first power state to the second power state.

13. The apparatus of claim 9, wherein the peripheral comprises a controller adapted to select a clock signal for the peripheral.

14. The apparatus of claim 9, wherein the peripheral comprises one of the following: a universal synchronous/asynchronous receiver/transmitter (USART) component, a universal asynchronous receiver/transmitter (UART) component, a serial peripheral interface (SPI) component and an inter-integrated circuit (I²C) component.

15. The apparatus of claim 9, wherein
the processor is adapted to transition between a first power state and a second power state, the second power state being associated with a greater power consumption than a power consumption associated with the first power state; and
the peripheral is adapted to change the clock frequency from a first frequency to a second frequency less than the first frequency.

16. The apparatus of claim 9, wherein
the processor is adapted to transition between a first power state and a second power state, the second power state being associated with a greater power consumption than a power consumption associated with the first power state; and
the peripheral is further adapted to:
transition between a third power state and a fourth power state, the fourth power state being associated with a greater power consumption than a power consumption associated with the third power state; and
trigger transition of the processor from the first power state to the second power state.

17. An apparatus comprising:
an integrated circuit comprising a processor and a peripheral, wherein:
the processor is adapted to communicate with the peripheral and the peripheral is adapted to regulate a clock frequency of the peripheral based at least in part on a power state of the processor.

18. The apparatus of claim 17, wherein the peripheral is adapted to change the clock frequency of the peripheral to prepare the peripheral for communication with the processor.

19. The apparatus of claim 17, wherein
the processor is adapted to transition between a first power state and a second power state, the second power state being associated with a greater power consumption than a power consumption associated with the first power state; and
the peripheral is adapted to change the clock frequency of the peripheral from a first frequency to a second frequency greater than the first frequency.

20. The apparatus of claim 17, wherein
the processor is adapted to transition between a first power state and a second power state, the second power state being associated with a greater power consumption than a power consumption associated with the first power state; and
the peripheral is adapted to change the clock frequency of the peripheral from a first frequency to a second frequency less than the first frequency.
